(19) United States
(12) Patent Application Publication
(10) Pub. No.: US 2012/0242270 A1
(43) Pub. Date: Sep. 27, 2012

(54) MOTOR DRIVING CIRCUIT AND MOTOR DRIVING SYSTEM

(75) Inventor: Jun Sodesawa, Tokyo (JP)

(73) Assignee: KABUSHIKI KAISHA TOSHIBA, Tokyo (JP)

(21) Appl. No.: 13/231,019

(22) Filed: Sep. 13, 2011

(30) Foreign Application Priority Data
Mar. 23, 2011 (JP) 2011-064067

(51) Int. Cl. H02P 7/00

(52) U.S. Cl. 318/558

(57) ABSTRACT

A motor driving circuit controls a driving of a motor based on communications with an external microcomputer. The motor driving circuit includes an AD converter that A/D converts an analog signal responsive to a motor current flowing through the motor and outputs a first digital signal resulting from the A/D conversion. The motor driving circuit includes a number-of-revolutions information producing circuit that outputs a second digital signal responsive to the number of revolutions of the motor based on the first digital signal output from the AD converter. The motor driving circuit includes an input/output circuit that outputs the second digital signal to the microcomputer. The number-of-revolutions information producing circuit sets a period of the second digital signal at a value associated with the number of revolutions of the motor and sets a duty cycle of the second digital signal at a value associated with information on the driving of the motor.

### CROSS-REFERENCE TO RELATED APPLICATION

This application is based upon and claims the benefit of priority from the prior Japanese Patent Application No. 2011-064067, filed on Mar. 23, 2011, the entire contents of which are incorporated herein by reference.

### BACKGROUND

1. Field

Embodiments described herein relate generally to a motor driving circuit and a motor driving system.

2. Background Art

A conventional motor driving system for driving a motor includes a motor driving circuit, a microcomputer, and a driver.

Typically, the motor driving circuit inputs the number of revolutions of a motor to the microcomputer.

Depending on the application of the motor driving system, motor information such as on the current, voltage and power of the motor needs to be output.

However, communications between the motor driving circuit and the microcomputer is restricted by the number of ports of the microcomputer allocated for motor drive control (one port, for example), and the variety of the transmitted information is also restricted.

### BRIEF DESCRIPTION OF THE DRAWINGS

FIG. 1 is a diagram showing an exemplary configuration of a motor driving system 1000 according to an embodiment 1;

FIG. 2 is a graph showing an exemplary waveform of the motor current flowing through the motor M shown in FIG. 1;

FIG. 3 is a graph showing an exemplary waveform of the second digital signal FG corresponding to the waveform of the motor current Im shown in FIG. 2; and

FIG. 4 is a graph showing the other exemplary waveform of the second digital signal FG corresponding to the waveform of the motor current Inn shown in FIG. 2.

### DETAILED DESCRIPTION

A motor driving circuit, according to an embodiment, controls a driving of a motor based on communications with an external microcomputer. The motor driving circuit includes an AD converter that A/D converts an analog signal responsive to a motor current flowing through the motor and outputs a first digital signal resulting from the A/D conversion. The motor driving circuit includes a number-of-revolutions information producing circuit that outputs a second digital signal responsive to the number of revolutions of the motor based on the first digital signal output from the AD converter. The motor driving circuit includes an input/output circuit that outputs the second digital signal to the microcomputer. The number-of-revolutions information producing circuit sets a period of the second digital signal at a value associated with the number of revolutions of the motor and sets a duty cycle of the second digital signal at a value associated with information on the driving of the motor.

In the following, an embodiment will be described with reference to the drawings. In the embodiment described below, it is assumed that the present embodiment is applied to control of a three-phase motor that involves controlling the three-phase driving voltage to control the number of revolutions. However, the present embodiment can be equally applied to other types of motors the number of revolutions of which is controlled by controlling the driving voltage.

### First Embodiment

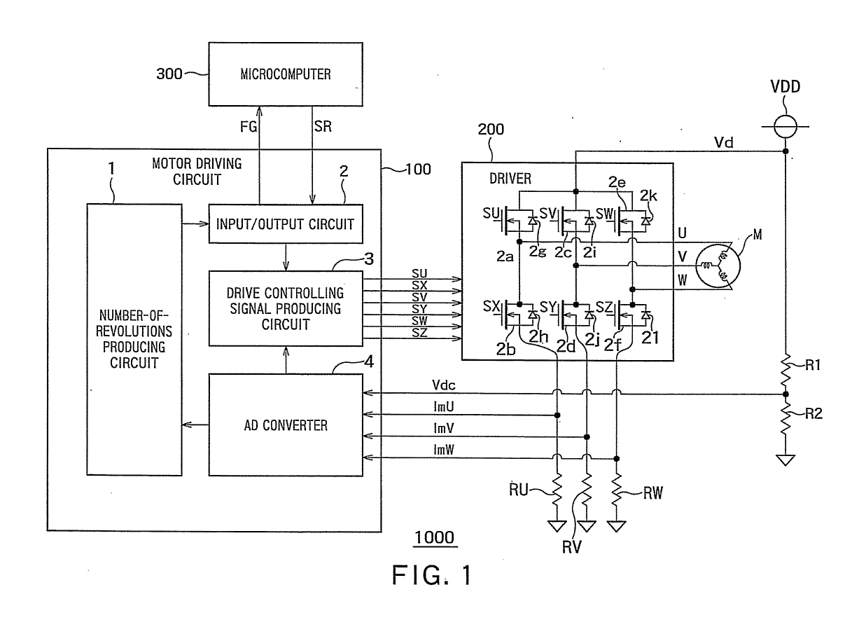

FIG. 1 is a diagram showing an exemplary configuration of a motor driving system 1000 according to an embodiment 1.

As shown in FIG. 1, the motor driving system 1000 includes a motor driving circuit 100, a driver 200, a microcomputer 300, a motor M, resistors RU, RV and RW, voltage divider resistors R1 and R2, and a direct-current power supply VDD.

The motor driving system 1000 is used to drive fans or compressors in an air conditioner or a refrigerator, for example.

The microcomputer 300 is configured to output a number-of-revolutions controlling signal SR that specifies the number of revolutions of the motor M to an input/output circuit based on a second digital signal (number-of-revolutions information signal) FG.

The direct-current power supply VDD is configured to output a power supply voltage Vd to the driver 200.

The voltage divider resistors R1 and R2 are connected in series between the direct-current power supply VDD and the ground. The voltage divider resistors R1 and R2 serve to divide the output voltage of the direct-current power supply VDD (power supply voltage Vd) and output a divided voltage Vdc.

In this embodiment, the motor M is a three-phase motor. As described above, the motor M may be other types of motors the number of revolutions of which is controlled by controlling the driving voltage.

The driver 200 is connected to the direct-current power supply VDD at one end and grounded at the other end via the resistors RU, RV and RW. The driver 200 is configured to supply three-phase driving voltages U, V and W derived from the power supply voltage Vd to the motor M in response to drive controlling signals SU, SX, SV, SY, SW and SZ.

As shown in FIG. 1, the driver 200 includes six n-MOS transistors 2a to 3f and six diodes 2g to 2l, for example.

The n-MOS transistor 2a that receives the drive controlling signal SU at the gate and the n-MOS transistor 2b that receives the drive controlling signal SX at the gate are connected in series between the direct-current power supply VDD and the ground. A terminal between the n-MOS transistor 2a and the n-MOS transistor 2b is connected to a U-phase coil of the motor M. The driving voltage U is supplied to the U-phase coil through the terminal.

The diode 2g is connected to the drain and the source of the n-MOS transistor 2a at the cathode and the anode thereof, respectively. The diode 2h is connected to the drain and the source of the n-MOS transistor 2b at the cathode and the anode thereof, respectively.

The n-MOS transistor 2c that receives the drive controlling signal SV at the gate and the n-MOS transistor 2d that receives the drive controlling signal SY at the gate are connected in series between the direct-current power supply VDD and the ground. A terminal between the n-MOS transistor 2c and the n-MOS transistor 2d is connected to a V-phase coil of the motor M. The driving voltage V is supplied to the V-phase coil through the terminal.

The diode 2i is connected to the drain and the source of the n-MOS transistor 2c at the cathode and the anode thereof, respectively. The diode 2j is connected to the drain and the source of the n-MOS transistor 2d at the cathode and the anode thereof, respectively.

The n-MOS transistor 2e that receives the drive controlling signal SW at the gate and the n-MOS transistor 2f that receives the drive controlling signal SZ at the gate are connected in series between the direct-current power supply VDD and the ground. A terminal between the n-MOS transistor 2e and the n-MOS transistor 2f is connected to a W-phase coil of the motor M. The driving voltage W is supplied to the W-phase coil through the terminal.

The diode 2k is connected to the drain and the source of the n-MOS transistor 2e at the cathode and the anode thereof, respectively. The diode 2l is connected to the drain and the source of the n-MOS transistor 2f at the cathode and the anode thereof, respectively.

The three-phase driving voltage U, V and W causes a current to flow through the three-phase coils, thereby driving the motor M.

The resistors RU, RV and RW are connected between the n-MOS transistor 2b and the ground, between the n-MOS transistor 2d and the ground, and between the n-MOS transistor 2f and the ground, respectively. That is, the current having flowed through the coils of the motor M flows through the resistors RU, RV and RW. Therefore, analog signals ImU, ImV and ImW indicating the voltage or current of the resistors RU, RV and RW depend on a motor current Im that flows through the motor M (the coils of the motor M).

The motor driving circuit 100 controls the driver 200 (the three-phase driving voltages U, V and W to the motor M) by the drive controlling signals SU, SX, SV, SY, SW and SZ based on communications with the external microcomputer 300, thereby controlling the driving of the motor M.

As shown in FIG. 1, the motor driving circuit 100 includes a number-of-revolutions information producing circuit 1, an input/output circuit 2, a drive controlling signal producing circuit 3 and an AD converter 4.

The input/output circuit 2 is connected to the microcomputer 300 and can communicate with the microcomputer 300.

The input/output circuit 2 receives the number-of-revolutions controlling signal SR output from the microcomputer 300 and outputs the signal to the drive controlling signal producing circuit 3. The input/output circuit 2 also outputs a second digital signal FG received from the number-of-revolutions information producing circuit 1 to the microcomputer 300.

The number of ports of the microcomputer 300 allocated to the communications with the input/output circuit 2 is one, for example.

The AD converter 4 A/D converts the analog signals (current or voltage) ImU, ImV and ImW depending on the motor current Im flowing through the motor M (the coils of the motor M) and outputs a first digital signal resulting from the A/D conversion.

The AD converter 4 receives the voltage Vdc produced by the voltage divider resistors R1 and R2 dividing the power supply voltage Vd supplied from the direct-current power supply VDD for driving the motor M. The AD converter 4 converts the voltage value (voltage Vdc) that depends on the power supply voltage Vd into a digital signal and outputs the digital signal.

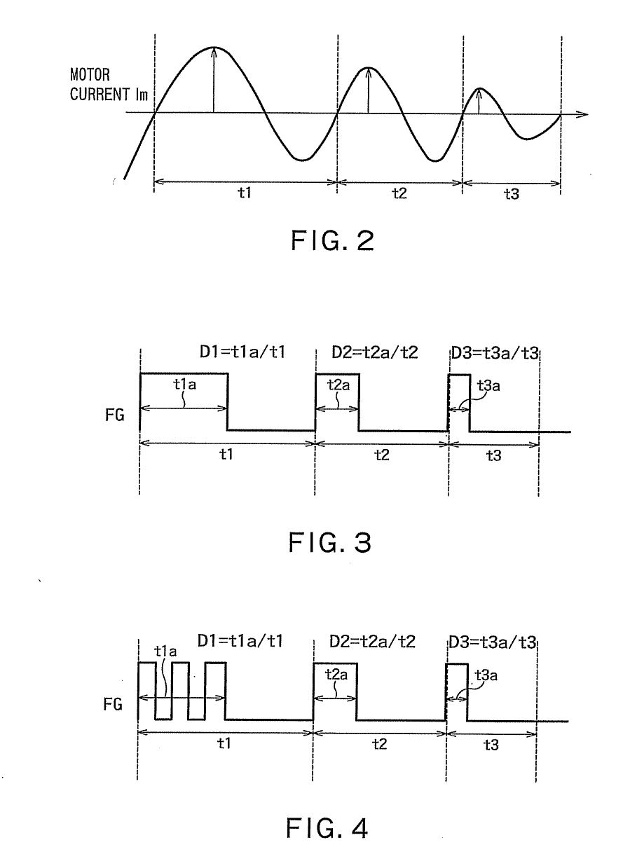

FIG. 2 is a graph showing an exemplary waveform of the motor current flowing through the motor M shown in FIG. 1.

As shown in FIG. 2, the motor current Im periodically varies in amplitude sinusoidally in synchronization with the revolution of the motor M. Thus, the number of revolutions of the motor M can be detected by detecting the periods t1, t2 and t3 of the amplitude of the motor current Im.

As shown in FIG. 1, the number-of-revolutions information producing circuit 1 detects the number of revolutions of the motor M from the acquired waveform of the motor current Im based on the first digital signal output from the AD converter 4, and outputs the second digital signal FG responsive to the detected number of revolutions of the motor M.

The number-of-revolutions information producing circuit 1 sets the period of the second digital signal FG to be a value associated with the detected number of revolutions of the motor M, and sets the duty cycle of the second digital signal FG to be a value associated with the information on the driving of the motor M.

FIG. 3 is a graph showing an exemplary waveform of the second digital signal FG corresponding to the waveform of the motor current Im shown in FIG. 2.

In FIG. 3, the periods t1, t2 and t3 of the second digital signal FG are set to be values associated with the detected number of revolutions of the motor M. For the periods t1, t2 and t3 of the second digital signal FG, durations t1a, t2a and t3a of the “High” level are set so that the duty cycles D1 (=t1a/t1), D2 (=t2a/t2) and D3 (=t3a/t3) are values associated with the information on the driving of the motor M.

In the example shown in FIG. 3, the periods of the motor current Im and the periods of the second digital signal are set to agree with each other. However, it is enough that the periods of the motor current Im and the periods of the second digital signal are in a one-to-one correspondence.

For example, the microcomputer 300 acquires the information on the driving of the motor M associated with the input duty cycle values of the second digital signal FG from a table (not shown) that shows a relationship between the information on the driving of the motor M and the duty cycle values.

The information on the driving of the motor M is any of the motor current Im, the voltage applied to the motor M, and the power consumed by the motor M.

The number-of-revolutions information producing circuit 1 can acquire the voltage applied to the motor M or the power consumed by the motor M based on the first digital signal associated with the analog signals ImU, ImV and ImW and the voltage Vdc.

Alternatively, the information on the driving of the motor M may be an error signal that indicates that the motor current Im is higher than a preset reference value, an error signal that indicates the voltage applied to the motor M is higher than a preset reference value, or an error signal that indicates that the power consumed by the motor M is higher than a preset reference value.

The microcomputer 300 may be configured to output the number-of-revolutions controlling signal SR to stop the revolution of the motor M in the case where the second digital signal FG contains the error signal.

As described above, with the motor driving circuit 100, the second digital signal FG can contain the information on the number of revolutions of the motor M and the information on the driving of the motor M, such as information on the motor current. That is, the variety of the information on the motor M that can be transmitted with the limited number of ports of the microcomputer 300 can be increased.

In the case where the information on the driving of the motor M associated with the duty cycles of the second digital signal FG is to be changed (the information is to be changed from the motor current to the voltage applied to the motor M, for example), the number-of-revolutions information producing circuit 1 sets the duty cycle of the second digital signal FG at a switch value, which indicates that the information is to be changed. Then, the number-of-revolutions information producing circuit 1 sets a duty cycle of the second digital signal FG that is associated with the new information on the driving of the motor M.

For example, in FIG. 3, if the duty cycle D2 is the switch value, the duty cycle D1 is associated with the old information on the driving of the motor M (the motor current, for example), and the duty cycle D3 is associated with the new information on the driving of the motor M (the voltage applied to the motor M, for example).

In this case, for example, when the microcomputer 300 detects that the duty cycle of the second digital signal FG is set at the switch value, the microcomputer 300 recognizes that the information on the driving of the motor associated with the value of the duty cycle of the following second digital signal FG has been changed (from the motor current to the voltage applied to the motor M, for example).

Then, the microcomputer 300 modifies the contents of the table described above and then can acquire the information on the driving of the motor M associated with the value of the duty cycle of the second digital signal FG input after detection of the switch value based on the modified table.

As described above, with the motor driving circuit 100, the second digital signal FG can contain the information on the number of revolutions of the motor M and the information on the driving of the motor M, such as information on the motor current, and the information on the driving of the motor M can be changed.

As shown in FIG. 1, based on the number-of-revolutions controlling signal SR that specified the number of revolutions of the motor M input from the microcomputer 300 via the input/output circuit 2, the drive controlling signal producing circuit 3 produces the drive controlling signals SU, SX, SV, SY, SW and SZ for driving the motor M at the number of revolutions specified by the number-of-revolutions controlling signal SR.

In the example shown in FIG. 3 described above, the duration of the “High” level of the second digital signal FG is continuous in one period. However, as shown in FIG. 4, the pulse of the second digital signal FG may be divided into a plurality of pulses shorter than a prescribed value. In that case, the number-of-revolutions information producing circuit 1 may associate the divisional pulses with specific information on the driving of the motor M.

As described above, with the motor driving circuit 100 according to the embodiment 1, the variety of the information on the motor that can be transmitted with the limited number of ports of the microcomputer can be increased.

In addition, since the motor driving circuit 100 can output two pieces of information with one output digital signal, the motor driving circuit 100 can be used for a complicated control of the microcomputer and thus for a wide variety of applications.

In addition, the number of cables of the microcomputer and the motor driving circuit 100 can be reduced.

In addition, the number of output terminals (ports) can be reduced, and the size and cost of the package can be reduced.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A motor driving circuit controlling a driving of a motor based on communications with an external microcomputer, the motor driving circuit comprises:
an AD converter that A/D converts an analog signal responsive to a motor current flowing through the motor and outputs a first digital signal resulting from the A/D conversion;
a number-of-revolutions information producing circuit that outputs a second digital signal responsive to the number of revolutions of the motor based on the first digital signal output from the AD converter; and
an input/output circuit that outputs the second digital signal to the microcomputer,
wherein the number-of-revolutions information producing circuit sets a period of the second digital signal at a value associated with the number of revolutions of the motor and sets a duty cycle of the second digital signal at a value associated with information on the driving of the motor.

2. The motor driving circuit according to claim 1, wherein the information on the driving of the motor is any of the motor current, the voltage applied to the motor, and the power consumed by the motor.

3. The motor driving circuit according to claim 1, wherein the information on the driving of the motor is any of an error signal that indicates the motor current is higher than a preset reference value, an error signal that indicates that the voltage applied to the motor is higher than a preset reference value, and an error signal that indicates that the power consumed by the motor is higher than a preset reference value.

4. The motor driving circuit according to claim 1, further comprising:
a drive controlling signal producing circuit that produces the drive controlling signal that drives the motor at the number of revolutions specified by the number-of-revolutions controlling signal based on the number-of-revolutions controlling signal that specifies the number of revolutions of the motor that is input from the microcomputer via the input/output circuit.

5. The motor driving circuit according to claim 2, further comprising:
a drive controlling signal producing circuit that produces the drive controlling signal that drives the motor at the number of revolutions specified by the number-of-revolutions controlling signal based on the number-of-revolutions controlling signal that specifies the number of revolutions of the motor that is input from the microcomputer via the input/output circuit.

6. The motor driving circuit according to claim 3, further comprising:
a drive controlling signal producing circuit that produces the drive controlling signal that drives the motor at the number of revolutions specified by the number-of-revolutions controlling signal based on the number-of-revolutions controlling signal that specifies the number of revolutions of the motor that is input from the microcomputer via the input/output circuit.

7. The motor driving circuit according to claim 1, wherein in the case where the contents of the information on the driving of the motor associated with the duty cycle of the second digital signal is to be changed, the number-of-revolutions information producing circuit sets the duty cycle of the second digital signal at a switch value that indicates that the information on the driving of the motor is to be changed, and then sets a duty cycle of the second digital signal associated with new information on the driving of the motor.

8. The motor driving circuit according to claim 2, wherein in the case where the contents of the information on the driving of the motor associated with the duty cycle of the second digital signal is to be changed, the number-of-revolutions information producing circuit sets the duty cycle of the second digital signal at a switch value that indicates that the information on the driving of the motor is to be changed, and then sets a duty cycle of the second digital signal associated with new information on the driving of the motor.

9. The motor driving circuit according to claim 3, wherein in the case where the contents of the information on the driving of the motor associated with the duty cycle of the second digital signal is to be changed, the number-of-revolutions information producing circuit sets the duty cycle of the second digital signal at a switch value that indicates that the information on the driving of the motor is to be changed, and then sets a duty cycle of the second digital signal associated with new information on the driving of the motor.

10. The motor driving circuit according to claim 4, wherein in the case where the contents of the information on the driving of the motor associated with the duty cycle of the second digital signal is to be changed, the number-of-revolutions information producing circuit sets the duty cycle of the second digital signal at a switch value that indicates that the information on the driving of the motor is to be changed, and then sets a duty cycle of the second digital signal associated with new information on the driving of the motor.

11. A motor driving system, comprising:
a motor;
a driver that supplies a driving voltage that drives the motor to the motor; and
a motor driving circuit that controls the driver by a drive controlling signal based on communications with an external microcomputer, thereby controlling the driving of the motor,
wherein the motor driving circuit comprises:
an AD converter that A/D converts an analog signal responsive to a motor current flowing through the motor and outputs a first digital signal resulting from the A/D conversion;
a number-of-revolutions information producing circuit that outputs a second digital signal responsive to the number of revolutions of the motor based on the first digital signal output from the AD converter; and
an input/output circuit that outputs the second digital signal to the microcomputer,
wherein the number-of-revolutions information producing circuit sets a period of the second digital signal at a value associated with the number of revolutions of the motor and sets a duty cycle of the second digital signal at a value associated with information on the driving of the motor.

12. The motor driving system according to claim 11, further comprising:
the microcomputer that outputs a number-of-revolutions controlling signal that specifies the number of revolutions of the motor to the input/output circuit based on the second digital signal,
wherein the motor driving circuit further comprises:
a drive controlling signal producing circuit that produces the drive controlling signal that drives the motor at the number of revolutions specified by the number-of-revolutions controlling signal based on the number-of-revolutions controlling signal that specifies the number of revolutions of the motor that is input from the microcomputer via the input/output circuit.

13. The motor driving system according to claim 11, wherein the information on the driving of the motor is any of the motor current, the voltage applied to the motor, and the power consumed by the motor.

14. The motor driving system according to claim 12, wherein the information on the driving of the motor is any of the motor current, the voltage applied to the motor, and the power consumed by the motor.

15. The motor driving system according to claim 11, wherein the information on the driving of the motor is any of an error signal that indicates the motor current is higher than a preset reference value, an error signal that indicates that the voltage applied to the motor is higher than a preset reference value, and an error signal that indicates that the power consumed by the motor is higher than a preset reference value.

16. The motor driving system according to claim 12, wherein the information on the driving of the motor is any of an error signal that indicates the motor current is higher than a preset reference value, an error signal that indicates that the voltage applied to the motor is higher than a preset reference value, and an error signal that indicates that the power consumed by the motor is higher than a preset reference value.

17. The motor driving system according to claim 11, wherein in the case where the contents of the information on the driving of the motor associated with the duty cycle of the second digital signal is to be changed, the number-of-revolutions information producing circuit sets the duty cycle of the second digital signal at a switch value that indicates that the information on the driving of the motor is to be changed, and then sets a duty cycle of the second digital signal associated with new information on the driving of the motor.

18. The motor driving system according to claim 12, wherein in the case where the contents of the information on the driving of the motor associated with the duty cycle of the second digital signal is to be changed, the number-of-revolutions information producing circuit sets the duty cycle of the second digital signal at a switch value that indicates that the information on the driving of the motor is to be changed, and then sets a duty cycle of the second digital signal associated with new information on the driving of the motor.

19. The motor driving system according to claim 13, wherein in the case where the contents of the information on the driving of the motor associated with the duty cycle of the second digital signal is to be changed, the number-of-revolutions information producing circuit sets the duty cycle of the second digital signal at a switch value that indicates that the information on the driving of the motor is to be changed, and then sets a duty cycle of the second digital signal associated with new information on the driving of the motor.

20. The motor driving system according to claim 14, wherein in the case where the contents of the information on the driving of the motor associated with the duty cycle of the second digital signal is to be changed, the number-of-revolutions information producing circuit sets the duty cycle of the second digital signal at a switch value that indicates that the information on the driving of the motor is to be changed, and then sets a duty cycle of the second digital signal associated with new information on the driving of the motor.
